(19) United States
(12) Patent Application Publication
(10) Pub. No.: US 2012/0290595 A1
(43) Pub. Date: Nov. 15, 2012

(54) SUPER-RECORDS

(76) Inventor: Jack Kreindler, Greater London (GB)

(21) Appl. No.: 13/512,016

(22) PCT Filed: Nov. 25, 2010
(86) PCT No.: PCT/IB10/55437

§ 371 Date: May 24, 2012

(30) Foreign Application Priority Data
Nov. 25, 2009 (GB) 0920645.9

(51) Int. Cl. G06F 17/30

(52) U.S. Cl. 707/756; 707/E17.005

(57) ABSTRACT

A method, apparatus, and article of manufacture for improving throughput and reducing latency for a computer database system with asynchronous updates, by taking advantage of information about relationships between records provided by the user. This information takes the form of rules that can be used to group a number of records that are often accessed together into a “super-record”, which the database system stores as a single unit, Updates to different records or parts of records within a super-record can be handled in a single atomic read-modify-write cycle, taking advantage of the asynchronous nature of updates to delay them so they can be combined with others, and thereby reducing the number of disk seeks required to perform the updates, When a single record or part of a record is requested to be read by the application, the entire super-record can be read in at very little extra cost, and the entire super-record loaded into a fast random-access cache in order to service subsequent reads to other data within the super-record without needing to read from the disk.

Despite the rise of solid-state disks and in-memory databases, the vast majority of databases are still stored on rotating magnetic disk, and will continue to be so until solid-state storage or other, future, storage systems are sufficiently cheap to compete with magnetic disks for bulk persistent storage.

Rotational disk storage is characterised by protracted “seek time” required to locate a requested item of data on the device, but a comparatively tiny amount of time then required to read each byte. Therefore, techniques that reduce the number of seeks, even at the cost of reading many more bytes, will improve throughput and reduce latency of accesses to such a device.

Although solid-state storage has a near-zero “seek time”, future storage technology may still benefit from techniques that reduce the number of accesses to a storage system while increasing the size of each access, as communications latency in (potentially wide-area) storage area networks may start to become a limiting factor.

Many applications desire fast random access to a large number of small records. Records in databases typically range from twenty to a few hundred bytes. Mass storage devices typically work in terms of 512-byte sectors as the smallest unit of transfer, but the time required to locate a given sector is usually in the order of milliseconds, while the time required to read a sector is usually in the order of microseconds; it is worth reading a thousand adjacent sectors rather than seeking to an unrelated position on the disk.

Because of this, many databases handle storage in “pages”, with sizes ranging from eight kibibytes to a mebibyte. Each page is stored as a set of adjacent sectors on-disk, and contains many records. Usually, the decision as to which records to place into a page is made rather crudely: only records from within a single table (or of the same type or class, in object-oriented databases) are considered, and they are chosen either because that group of records happened to be inserted into the database at about the same time, or purely arbitrarily. At best, records may be sorted on some field and then adjacent records placed into pages together. This allows the optimization of large Online analytical processing (OLAP) queries, which typical require accessing more than one record of the database.

However, traditional Online Transaction Processing (OLTP) workloads, which involve simple single record queries, are typically not helped by paging, as the access order of records within a table is usually considered random; each access to a record under an OLTP workload often involves a seek on the underlying disk, unless the record is located within a cache due to a previous access.

Many current OLTP databases offer synchronous updates. A synchronous update is where the application making the database query waits until it receives a “Finished” message from the database is received before performing any other database operations. Due to the limitations of having a single copy of the data, the database cannot honestly report to the application that an update has completed successfully until the affected records have been written to disk. This puts the implementation of such databases under pressure to complete writes quickly, rather than to go to great lengths to reduce the number of writes by, for example, arranging for records that are likely to be updated together to go into the same page, so they can all be updated in a single operation.

Thus, there exists a desire to reduce the average number of expensive disk seeks required to read, update, or create a record in an OLTP environment.

### SUMMARY OF THE INVENTION

An aspect of the invention provides a database system comprising: a database having: a set of data records, and a set of super-records, a mapping from each data record to a super-record, and a write processing unit comprising a write memory and configured to: receive a write request comprising at least one write instruction and a corresponding target data record identity identifying the data record on which the write instruction is to be performed, all target data records identified by the write request being mapped to a common super-record, read from the database into the write memory, a subset of the set of data records comprising each data record mapping to a common super-record with that of the target data record(s), perform the plurality of write instructions on the target records of the data record subset in the write memory, subsequent to the step immediately above, store data records of the write memory that are mapped to a common super-record with that of the target data record(s) logically together in the database.

Another aspect of the invention provides a method of storing data in a database, the database comprising: a set of data records, a set of super-records, each data record having a mapping to a super-record, the method comprising the step of storing data records mapped to a common super-record logically together in the database.

### DESCRIPTION OF THE DRAWINGS

The present invention will now be described by way of example with reference to the accompanying drawings, in which:

FIG. 1 shows an invoice database aspect of the invention.

FIG. 2 shows an aspect of the invention for coalescing write instructions in the write instruction queue.

FIG. 3 shows an aspect of the invention in which super-records are used to manage cache memory.

### DETAILED DESCRIPTION

To overcome the limitations of the prior art described above, and to overcome other limitations that will become apparent upon reading and understanding the present specification one aspect of the invention provides a technique for identifying related records that are likely to be accessed (where an access may be a read or an update, or even creation of the records) within a short time span of each other.

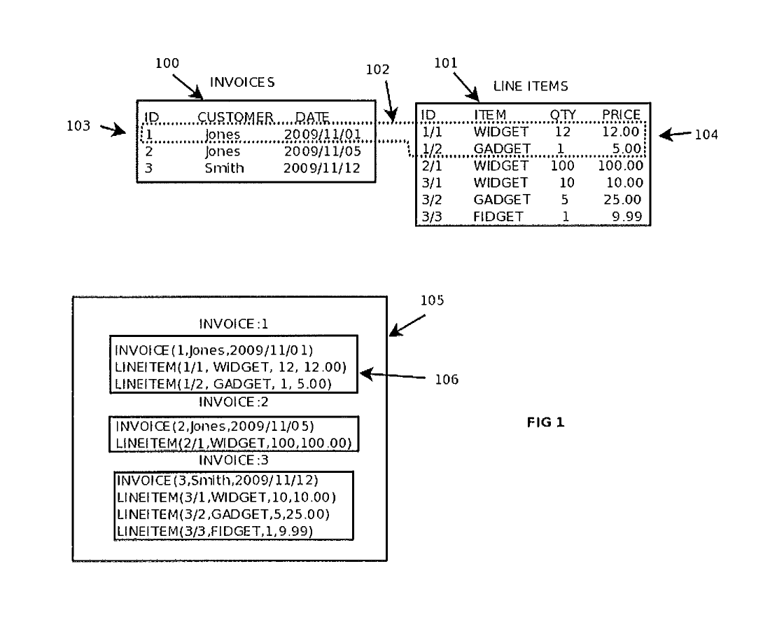

Often, various small records from different tables contain different pieces of information about a “virtual object” that does not exist directly within the system. In an example shown in FIG. 1, an accounting system may have a notion of an invoice; but that invoice (102) is represented within the system as a single record (103) in an “invoices” table (100), plus several records (104) in a “line items” table (101) that each reference the invoice record, they being aggregated components of the invoice as a whole; and perhaps some records in a “payments” table. Displaying the status of the invoice would require fetching the invoice record, then fetching all line items that reference that invoice, then fetching all payments that reference that invoice.

This first aspect of the invention consists of a mechanism for allocating records (103,104) to super-records (106) by allowing the user of the database to provide a function, set of rules, or other mapping from the primary key of a record to a super-record. For example, the aforementioned accounting system might specify that an invoice with primary key K should be placed into a super-record identified by the code “invoice:K”, that a line item with primary key “K/N” (meaning line N of invoice K) should also be placed into the same super-record, “invoice:K”, and likewise for a payment referencing that invoice. These super-records can then be stored together in a physical table (105) rather than in separate tables (100,101), thus better reflecting expected access patterns.

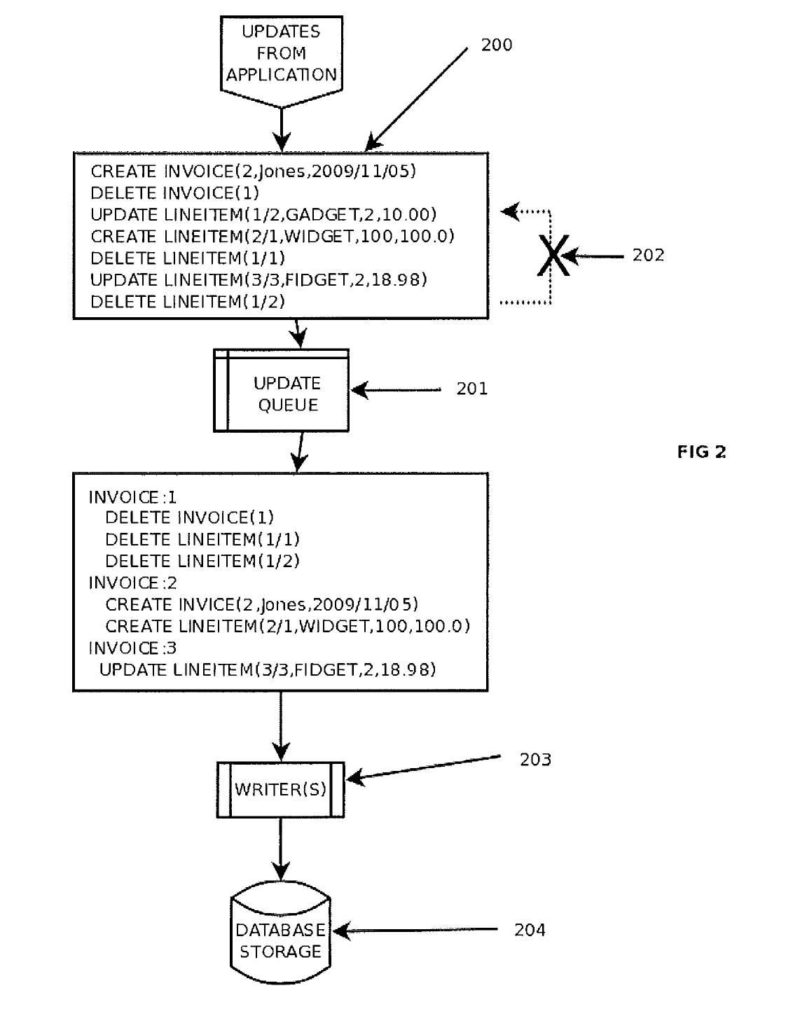

Another aspect of the invention shown in FIG. 2 is the use of this super-record information to coalesce asynchronous write requests. As write requests (which may be record creations, updates, or deletions) (200) are received by the database system, being asynchronous requests, there is pressure to get them written to the slow stable storage in order to free up memory and to reduce the scope for them to be lost due to a system failure; but without a hard deadline to do this, it is practical to maintain a large backlog of pending update requests (201) if benefits can be gained from them. Therefore, there is a corresponding method of utilising a queue of writes within the database system along with super-record information to optimise writes:
1. Updates (200) (including inserts and deletes) are added to the queue (201), tagged with the ID of the super-record containing the record, computed by using the user-supplied rules.
2. If there are no other updates to the same super-record, then the update can be added to the queue (201).
3. if there is an existing update to other records within the same super-record, but which do not conflict with the new update, then the update can be attached to the existing updates.
4. if there is an existing update within the same super-record, but which conflicts with the new update (202) (eg, the new update deletes a record that is created or modified by the existing update), then the database has to merge the two updates in an appropriate manner (eg, if a delete arrives when a preceding update already exists, then the delete can replace the update, as updating the record then deleting it immediately would be superfluous).

This will result in a queue of updates (201), grouped by super-record. Groups of updates to the same super-record can then be pulled from the head of the queue by one or more processes or threads (203), which can apply them by the following method:
1. Read the super-record that the updates refer to from the stable storage medium (204). If it does not already exist, then produce an empty super-record and use that instead.
2. Apply the updates from the queue into the copy of the super-record held in memory. Create new records within it for inserts, update existing records for updates, and delete records for deletes, to create an updated super-record in memory.
3. Write the new super-record to stable storage (204).

The length of the queue (201) will depend upon the rate at which the stable storage updating processes can remove super-record updates from the queue (201), and the rate at which new updates are inserted into the queue (201). Any update which is coalesced into an existing super-record update entry in the queue (201), or outright superseded (202) will result in very little extra workload for the stable storage updating processes (203) compared to an update to a super-record not previously present in the queue (201), so to a first approximation, the rate of arrival of new super-records to update is what matters. If the rate of arrival of new super-records exceeds (the arrival rate) the rate at which the requests can be serviced by being updated on stable storage (the service rate), the queue (201) will grow without bound, which is undesirable, so some mechanism of throttling the arrival rate is required, such as by applying a “back pressure” to the application dependent on the queue length. In a system with an arrival rate that is much less than the service rate, the queue (201) will be virtually empty, with new updates being snapped up by an otherwise idle updating process (203) almost immediately; little coalescing of writes will occur, but as in this situation there is capacity to spare, this is of no consequence. Queue length management only becomes an issue when the arrival rate becomes close to the service rate. The construction of an ideal queue length management system depends on other aspects of the system unrelated to this invention, but such a system should allow updates to arrive until the queue (201)reaches a length that offers a reasonable trade-off between opportunities for coalescing updates versus memory usage and the scope for losing updates in the event of a server failure, then throttle the arrival rate until it approximately matches the service rate, in order to keep the queue (201) around that length.

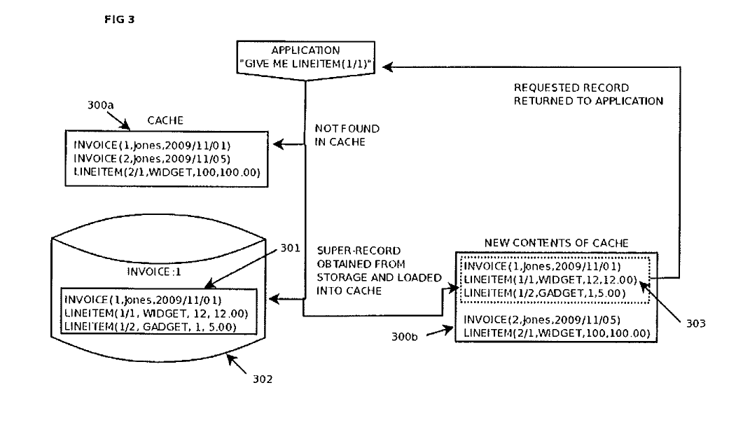

FIG. 3 shows another aspect of this invention in which super-records are used to intelligently “read-ahead”. As the application is likely to request records from within the same super-record within a short time period, there is a corresponding method for handling requests to read a record by:
1. Using the user-supplied rules to find the ID of the super-record containing the desired record
2. Consult the cache (300a) to see if that super-record is present
3. If it is, then extract the desired record from within the super-record, and return it
4. If it is not, then read the super-record (301) from stable storage (302), insert it into the cache (300b), and then extract the desired record (303) and return it.

The same cache can be used in the previous aspect of the invention, where the method requires the current state of the super-record to be read so that pending changes can be applied to it, to gain further performance enhancements in the expectation that super-records being updated are likely to have recently been read.

Replicated databases, however, are much less prone to system-wide failures, so have the potential to report an update as successfully completed as soon as it has been transmitted to more than one server, so that no single server failure can cause the loss of the update. This opens greater scope for intelligence in arranging updates.

According to another aspect of the present invention there is provided a computer-implemented apparatus for using information about application-level structural access patterns to optimise access to a database, embodying:
1. A stable storage medium, storing a number of variable-length super-records, each identified by a super-record ID
2. An application, which issues requests to read, create, modify, or delete records
3. A set of rules, provided by the application, that can be used to compute the super-record ID of a record, given the record's own unique ID (which, in a relational database, might consist of the name of the table and a primary key value)
4. A super-record cache, on a fast but potentially volatile storage medium, also storing a number of variable-length super-records, each identified by a super-record ID
5. An update queue, where the entries in a queue are some representation of a list of updates to apply to records within a single super-record, the ID of which is contained in or otherwise deducible from the queue entry, stored on a fast but potentially volatile storage medium, with some means of finding the entry for a given super-record ID if one is present in the queue.
6. Database system software that receives the requests from the application, servicing reads and placing updates in the queue
7. One or more instructions, performed by the database system software, for performing the methods described above to service the application's requests and to apply updates from the queue to the stable storage medium

According to another aspect of the present invention there is provided an article of manufacture comprising a carrier tangibly embodying one or more instructions that when executed by a computer causes the computer to perform any or all of the above methods for using information about application-level structural access patterns to provide access to a database.

In the following description of the preferred aspect, reference is made to a specific aspect in which the invention may be practised. It is to be understood that other aspects may be utilised and structural changes may be made without departing from the scope of the present invention.

### OVERVIEW

The present aspect, known as “Data Store” or “DS”, comprises a fully replicated database. The records are assigned to super-records using a simple rule, where a number of tables are assigned to a “table group”, and the ID of the record containing a super-record consists of the name of the table's table group combined with the unique ID of the record, up to a special separator if present, or the entire unique ID of the record if not. Each table group has a corresponding B-Tree on disk, which stores super-records, identified by the remaining part of the super-record ID, that being the primary key of the record (truncated at the separator, if present). In other words, all records within a table group having the same unique ID (up to the separator, if present) will be assigned to the same super-record, and there is a separate B-Tree per table group.

Secondary indices are stored in additional B-Trees. The DS software running on each server is split into client and server parts, communicating by sharing the on-disk replica store and a shared memory region. As well as the stable replica store which contains a full replica of the database on every server, there is also a “consistency store”, which is used for purposes beyond the scope of this invention, that acts as a form of distributed cache. The consistency store contains records, in fast but volatile memory, that are keyed on the table name and the record's unique ID; this key is hashed and used to pick a server responsible for the record, so the records in the cache are distributed across the available servers.

The client uses TCP connections to the consistency servers, and uses a reliable multicast protocol to asynchronously advertise the update to the replica servers, and handles all reads from replica servers by directly reading the on-disk replica store on the server. A separate executable process embodies the consistency server, which is conventionally but not necessarily executed on the same physical servers as the replica servers; however, future versions of the DS will incorporate the replica server functionality into the DS daemon in order to share replica and consistency stores; but in the current aspect, the consistency server stores records in volatile memory while the replica server stores them on persistent disk.

The client part of the DS software exposes a programming interface to the user's application software, which provides various operations to access the replicated database. The operations of particular interest cover reading records with ‘GDSGet’, and updating, deleting or inserting records with ‘GDSSet’ and ‘GDSDelete’ (the latter being a wrapper for ‘GDSSet’ that just sets a record to the ‘deleted’ state). The DS provides cursor operations to obtain multiple records from the database, but they use the same methods to access each individual record within the super-records.

### GDSGet

GDSGet uses “consistency servers” as part of a separate invention, the details of which are unrelated to this one. However, then consistency servers are also used as a cache, so GDSGet uses the following method to obtain a record, given the table name and the record's unique ID within the table:
1. Check the consistency servers to see if the record is already present in the cache.
2. If the consistency servers have the record, then return it to the user.
3. If not, or there is an error communicating with the consistency servers, then consult the definition of the table to find its table group.
4. Look for a super-record in the table group, by looking for an entry in the B-Tree corresponding to the table group, using the record's unique ID as the key.
5. If none is found, the record does not exist, so return this fact to the user.
6. If one is found, then it consists of a list of records, each identified with the name of the table it came from.
7. For each record in the super-record, send it to the consistency servers to be cached.
8. If there is a record corresponding to the desired record, and it is a “deleted record” marker, then the record does not exist, so return this fact to the user.
8. Otherwise, return the found record to the user.

### GDSSet

GDSSet, if various other conditions beyond the scope of this invention are met, informs the consistency servers of the new version of the record, then issues a multicast addressed to the DS software on every node, containing the table name, the record's unique ID, a timestamp, and the new contents of the modified record (which may be a special marker value representing a deleted record). New records are created by calling GDSSet with their initial value.

### GDSDelete

GDSDelete is a convenience function that calls GDSSet, passing it the marker value for a deleted record.

### The DS Daemon

The DS Daemon runs on each server, and runs many threads.

One thread listens for multicasted messages (including updates from clients), and places them into an internal queue. This thread does no per-message processing, as it has to quickly fetch messages from a limited buffer before it overflows.

A second thread waits on the other end of the same queue, for messages enqueued by the first thread. It proceeds to analyse each message in turn, performing various administrative and accounting actions performed upon every message received, then dispatching on the message type to handle the message.

If the message is an update from a client, then the following method is performed:
1. The table group of the table the record is destined for is looked up in the schema
2. Each table group has its own super-record update queue within the Daemon's memory, so the corresponding update queue for that table group is located.
3. The update queue is searched to see if there is already an entry keyed on the unique ID of the record
4. If not, one is created and inserted at the tail of the queue, and the record is placed within it, subkeyed on the table name.
5. If there is one, then it is searched to see if there is already a record within, subkeyed on the table name.
6. If there is not, then the record is placed within it, subkeyed on the table name.
7. If there is one, and the contents have an earlier timestamp than the timestamp on the new record, then the new record replaces the old.
8. Otherwise, there is one but it has a later timestamp than the new record, so the new record isn't actually that new at all, so is discarded.

If it is not an update from a client, then other appropriate actions, beyond the scope of this invention, are performed.

When the second thread has processed the message, it then performs the following method:
1. If there are one or more messages waiting for it in the message queue from the first thread, repeat the above process to handle the next one.
2. If there are one or more entries in the update queues of any of the table groups, then obtain the entry at the head of each non-empty queue, and for each of them:
   1. Open the B-Tree corresponding to the table group
   2. Fetch the super-record with the key that is the key of the super-record update entry in question; if there is none, then create an empty one
   3. For each update within the update entry:
      1. Check if there is a record associated with that table in the super-record
      2. If there is none, then copy the timestamp and value from the update entry into the super-record, keyed on the table
      3. If there is one, but it has an earlier timestamp than in the update entry, then replace it with the value and timestamp from the update entry
      4. If there is one, but it has a later timestamp than in the update entry, then do nothing
   4. Write the new super-record into the B-Tree, overwriting any previous value of it, keyed on the key of the update entry
3. If there are any periodic tasks due to be performed, do them
4. Block until a message appears in the message queue, or a timeout of one second expires
5. Repeat the whole process

Some alternative ways of accomplishing the present invention are described. Those skilled in the art will recognise that the invention may be applied to many different database structures with units of logical access other than records, such as object-oriented databases, content-addressable stores and file systems as well as the record-oriented relational database of the preferred aspect; it may be applied to super-records, the units of physical access, stored in any of a number of data structures including but not limited to hashtables, B-Trees, other forms of tree, ISAM files, and others; and various different mechanisms for identifying the super-record that should contain any given record, object, blob, or other unit of storage could be used, including but not limited to systems of rules, arbitrary user functions, or having the application compute the super-record ID itself in an arbitrary manner and supply it along with the record ID in every operation.

1. A database system comprising:
a database having:
a set of data records, and
a set of super-records,
a mapping from each data record to a super-record, and
a write processing unit comprising a write memory and configured to:
receive a write request comprising at least one write instruction and a corresponding target data record identity identifying the data record on which the write instruction is to be performed, all target data records identified by the write request being mapped to a common super-record,
read from the database into the write memory, a subset of the set of data records comprising each data record mapping to a common super-record with that of the target data record(s),
perform the plurality of write instructions on the target records of the data record subset in the write memory,
subsequent to the step immediately above, store data records of the write memory that are mapped to a common super-record with that of the target data record(s) logically together in the database.

2. The database system of claim 1, wherein the mapping from each data record to a super-record is generated according to a function or a set of rules.

3. The database system of any preceding claim, wherein the data records mapped to a common super-record are stored in a physically contiguous manner in the database.

4. The database system of claim 1, further comprising a write request buffer, the write processing unit being configured to receive write requests from the write request buffer, the write request buffer being configured to:
receive a new write request, comprising at least one write instruction and corresponding target data record identity identifying the data record on which the write instruction is to be performed,
if there is an existing write request targeting data records different but mapped to a common super-record to the data records targeted by the new write request, adding the write instruction(s) and corresponding target data record identity(s) to the existing write request.

5. The database of claim 4 or 5, the write request buffer being further configured to:
if there is no existing write request targeting data records mapped to a common super-record to the data records targeted by the new write request, adding the new write request to the write request buffer.

6. The database system of any preceding claim, further comprising a read processing unit comprising a cache memory and configured to:
receive a new read request, comprising an indication of a desired data record,
if a copy of the desired data record is stored in the cache memory, returning the copy of the data record stored in the cache memory,
if a copy of the desired data record is not stored in the cache memory, copy all data records mapped to the super-record common with the desired data record from the database to the cache memory and return the copy of the data record stored in the cache memory.

7. The database system of claim 1 as dependent on claim 6, wherein the step, performed by the write processing unit, of reading from the database into the write memory, a subset of the set of data records comprising each data record mapping to a common super-record with that of the target data record(s), is performed using the read processing unit of claim 6.

8. A method of storing data in a database, the database comprising:
a set of data records,
a set of super-records, each data record having a mapping to a super-record,
the method comprising the step of storing data records mapped to a common super-record logically together in the database.

9. A database system substantially as described with reference to and as shown in the accompanying figures.

10. A method of storing data in a database substantially as described with reference to and as shown in the accompanying figures.
